(19) United States
(12) Patent Application Publication
(10) Pub. No.: US 2005/0125279 A1
(43) Pub. Date: Jun. 9, 2005

(54) Method and structure for privacy preserving data mining

(75) Inventor: Chai Wah Wu, Poughquag, NY (US)

Correspondence Address: MCGINN & GIBB, PLLC, 8321 OLD COURTHOUSE ROAD, SUITE 200, VIENNA, VA, 22182-3817, US

(73) Assignee: International Business Machines Corporation, Armonk, NY (US)

(21) Appl. No.: 10/725,382

(22) Filed: Dec. 3, 2003

(51) Int. Cl. G06F 17/60

(52) U.S. Cl. 705/10

(57) ABSTRACT

A method (and structure) for conducting a survey, includes, for each question in the survey, establishing a bin for each of a possible response to the question. For each bin, a perturbing mechanism is established that perturbs a content of the bin. The perturbing mechanism has a statistical parameter having a known value. An estimation for the distribution of the survey answers is obtained by averaging the perturbed contents of the bins and subtracting the corresponding known statistical parameter value.

### BACKGROUND OF THE INVENTION

1. Field of the Invention

The present invention generally relates to data mining without compromising the privacy of individuals whose data are collected. More specifically, an indicator vector from the user is generated and then perturbed by adding a vector of random numbers. Aggregate statistics of these vectors can then be computed very efficiently, using a one-step algorithm with low storage requirements, while preserving the properties of small information loss and small privacy loss.

2. Description of the Related Art

Data collection and mining compromise the privacy of people whose data are collected. In recent years, there have been privacy concerns over the proliferation of gathering of personal information by various institutions and merchants over the Internet. This has led to the development of data mining algorithms that preserve the privacy of those whose personal data are collected and analyzed.

In a previously known solution to this problem, a random value from a known distribution is added to the individual data. This perturbation is performed at the source of the data so that the true value of the data is not known to the data mining algorithm. The random value is tied to the individual data, so that repeated queries by the data collection party return the same perturbed value. In these applications, the distribution of the original data set is important and estimating it is one of the goals of the data mining algorithm.

This distribution is estimated via an iterative algorithm. An algorithm based on the Expectation Maximization (EM) algorithm was subsequently shown to have desirable properties such as the ability to have low privacy loss and high fidelity estimates of the distribution of the data set. Each iteration of EM requires computation which is proportional to the size of the data set and to the number of points in the estimate. This can require large computation time to estimate the distribution.

Thus, a drawback of this conventional method is that the algorithm to recover the aggregate statistics of the original data from the perturbed data is iterative, complicated, memory intensive, and takes many computations. Furthermore, in this conventional method, it can be difficult to prove that the privacy loss or information loss is small. In addition, the EM algorithm might not converge to the correct estimate.

The present inventor recognized that what remains missing in the art of data mining is a method that allows arbitrarily small privacy loss of the individuals whose personal data are collected and analyzed, arbitrarily high fidelity in the estimate (e.g., zero information loss), provides a simple estimate, and is fast (e.g., ideally, a single step would estimate the unknown distribution) and memory efficient.

### SUMMARY OF THE INVENTION

In view of the foregoing and other exemplary problems, drawbacks, and disadvantages of the conventional systems, it is an exemplary feature of the present invention to provide a method (and structure) of data mining having the characteristic of both a small privacy loss for individuals whose personal data are being collected and analyzed and a high fidelity in the estimate of the data mining result.

It is another exemplary feature of the present invention to provide a method of data mining that uses a simple, easy, and fast algorithm to recover the unknown distribution.

It is yet another exemplary feature of the present invention to provide a method of data mining with modest memory requirements.

To achieve the above and other exemplary features, goals, and effects, in a first exemplary aspect of the present invention, described herein is a method (and structure) of conducting a survey, including, for at least one question in the survey, establishing a bin for each of a possible response to the question, and for each bin, establishing a perturbing mechanism that perturbs a content of the bin, the perturbing mechanism having a statistical parameter with a known value.

In a second exemplary aspect of the present invention, also described herein is a system for conducting a survey, including at least one of a memory means for serving as a database to store a plurality of respondent's responses to a question in the survey, wherein each response comprises a plurality of bins corresponding to a number of possible answers for the question and each bin is perturbed in value by a perturbing mechanism, a survey set-up means for setting up a question in the survey, wherein the setting up the question comprises establishing a bin for each of a possible response to the question and establishing a perturbing mechanism that perturbs a content of the bin, the perturbing mechanism having a statistical parameter with a known value, a respondent means for allowing a respondent to select at least one of the possible answers to the question, for perturbing a content of each bin in the question upon completion of the selection by the respondent, for generating a perturbed indicator vector that includes the contents of all the bins in the question after perturbation, and for transmitting the perturbed indicator vector to the database, and an analysis means for retrieving and analyzing a content of the bins, and a user interface means for allowing a user to interface with at least one of the memory means, the survey set-up means, the said respondent means, and the analysis means.

In a third exemplary aspect of the present invention, also described herein is a signal-bearing medium tangibly embodying a program of machine-readable instructions executable by a digital processing apparatus to perform a method of at least one of conducting, processing, and analyzing a survey, as just described above.

In a fourth exemplary aspect of the present invention, also described herein is a business method, including at least one of: preparing a survey question in a manner such that, for at least one question in the survey, establishes a bin for each of a possible response to the question, for each bin, establishes a perturbing mechanism that perturbs a content of the bin, the perturbing mechanism having a known value for a statistical parameter; allowing users to respond to the survey question; at least one of receiving and storing the survey question; transmitting a perturbed indicator vector of a respondent's response to a survey question prepared in the manner described, the perturbed indicator vector comprising an information structure including the contents of all bins of the question after each of the bins has been perturbed; at least one of receiving the perturbed indicator vector and storing the perturbed indicator vector in a database; at least one of retrieving and analyzing data for the survey question to provide a result of the survey; and at least one of transmitting, receiving, printing out, and receiving a printed copy of the result.

In a fifth exemplary aspect of the present invention, also described herein is a method of conducting a survey, including for at least one question in the survey, generating an indicator vector from a vector whose components respectively represent a possible response to the question, the indicator vector indicating which of said possible responses were selected by a respondent, and adding a perturbation vector to the indicator vector to provide a perturbed indicator vector, the perturbation vector having a same number of components as the indicator vector, each component in the perturbation vector resulting from a perturbation mechanism that is independent of the perturbation mechanism of the other components, wherein the perturbation mechanism has a statistical parameter whose value is known.

In a sixth exemplary aspect of the present invention, also described herein is a method of privacy-preserving data mining by using the steps just described above.

In a seventh exemplary aspect of the present invention, also described herein is a data mining apparatus (and signal-bearing medium), including an indicator vector generator to generate an indicator vector representing a response by a respondent to a survey question, a perturbation vector generator to generate a perturbation vector, and a perturbed indicator vector generator to add the indicator vector with the perturbation vector, wherein, for the question, a predefined possible-response vector exists whose components respectively represent a possible response to the question, the indicator vector comprising a modification of the possible-response vector that represents which one or ones of the possible responses were selected by a respondent, the perturbation vector comprising a vector having a same number of components as the indicator vector, each component in the perturbation vector resulting from a perturbation mechanism that is independent of the perturbation mechanism of the other components, each perturbation mechanism having a statistical parameter with a value that is known.

### BRIEF DESCRIPTION OF THE DRAWINGS

The foregoing and other exemplary features, aspects, and advantages will be better understood from the following detailed description of an exemplary embodiment of the invention with reference to the drawings, in which:

FIG. 1 shows an exemplary format 100 for a single question in a survey that demonstrates the concept of survey question information bins, as used in the present invention;

FIG. 2 shows an exemplary system 200 in which an on-line survey might be conducted;

FIG. 3a shows an exemplary encoding scheme 300 that can be used to derive an indicator vector for a respondent's answer to a question, as represented by the information bins;

FIG. 3b shows an alternative interpretation 350 of the encoding scheme 300 in FIG. 3a;

FIG. 4 shows the correspondence 400 between each information bin and a corresponding random number generator (RNG);

FIG. 5 shows an exemplary indicator vector 500 as contents in the bins, where each bin has been perturbed by its corresponding RNG and is ready to be delivered as a perturbed indicator vector to the database;

FIG. 6 demonstrates an exemplary extraction process 600 for estimating the distribution of the responses from the perturbed indicator vectors for a single survey question, such as shown in FIG. 5;

FIG. 7 shows an exemplary numerical example 700 of an extraction as executed as shown in FIG. 6;

FIG. 8 shows a flowchart of an exemplary process 800 to set up survey questions so as to implement the present invention;

FIG. 9 shows a flowchart of an exemplary process 900 for perturbing an indicator vector prior to reporting a respondent's answer to a survey question;

FIG. 10 shows a flowchart of an exemplary process 1000 for extracting the distribution of the reported perturbed indicator vectors of a survey question from an arbitrarily large number of respondents;

FIG. 11 shows modules of an exemplary software program 1100 to execute the process of the present invention;

FIG. 12 illustrates an exemplary hardware/information handling system 1200 for incorporating the present invention therein;

FIG. 13 illustrates a signal bearing medium 1300 (e.g., storage medium) for storing steps of a program of a method according to the present invention; and

FIG. 14 shows a method using punch cards, which can be used in an exemplary method for data collection and perturbation.

### DETAILED DESCRIPTION OF EXEMPLARY EMBODIMENTS OF THE INVENTION

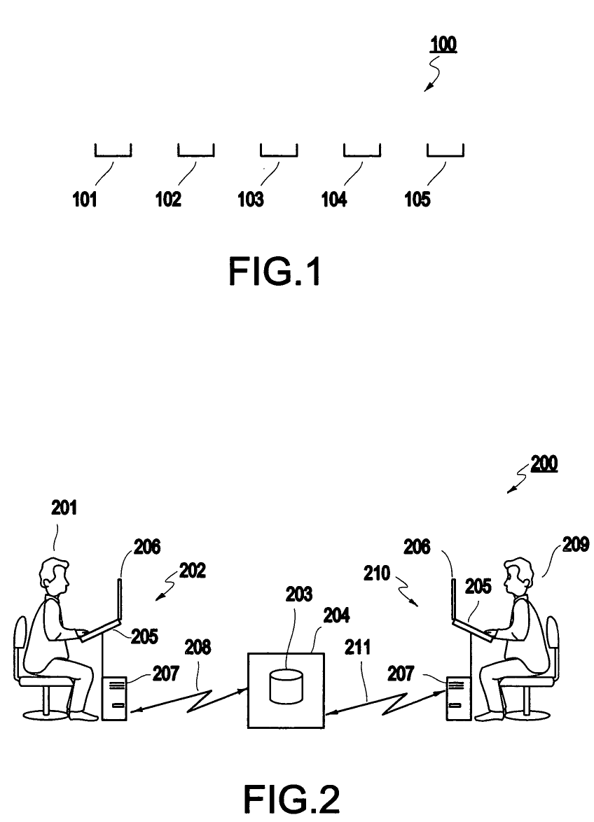

Referring now to the drawings, and more particularly to FIGS. 1-14, an exemplary embodiment of the present invention will now be described.

FIG. 1 shows an exemplary format 100 for a single survey that could be used to implement the concepts of the present invention. In this exemplary format 100 are shown symbolically five categories 101-105 (also referred to as “bins” in this discussion) for one question in the survey. The first bin 101 might represent, in one survey, a response such as “strongly agree”. The second bin 102 might represent in the same survey a response “somewhat agree”. Similarly, the third bin 103 might represent “neither agree nor disagree”, the fourth bin 104 might represent “somewhat disagree”, and the fifth bin 105 might represent “strongly disagree”.

In a second survey, the format 100 might represent age categories. For example, the five bins might represent, respectively, the age categories: 0-19, 20-39, 40-59, 60-79, and 80-99. One of ordinary skill in the art, taking the present application as a whole, taking the present application as a whole, will readily recognize that the number of categories and the meaning of each of the categories will vary, depending upon the specific question being asked. Other variations might include the survey asking the age of the user (rather than an age category), and the answer is then categorized into the age categories by the data input module. In other words, the bins can denote the list of possible answers to the survey question or they can denote a plurality of ranges of the possible answers to the question.

The concept of bins 101-105 is a significant feature of the present invention and serves as one distinction over the conventional method described earlier. As explained below, in the present invention, each bin 101-105 is separately perturbed in order to generate the indicator vector that reports the respondent's answer to the survey question (which is now masked by the perturbations) to the database ultimately used for the data mining process.

Additionally, in the data distribution extraction process, for any one question, the same bin will be averaged for all the responses to that question. The use of an indicator vector and perturbing this vector is in contrast to the conventional method, where the single value of the answer is perturbed and this single perturbed value is sent to the database for collection and analysis.

FIG. 2 shows an exemplary system 200 in which a survey might be conducted in accordance with the present invention. In system 200, the individual 201 who is responding to a survey provides responses at computer station 202. The responses from individual 201 are then each encoded, in accordance with a format to be shortly described, perturbed for privacy, and then transmitted from computer 202 to a collection center, such as a database 203 in a server 204, that has been set up to collect data from the survey from all respondents (e.g., such as individual 201).

One of ordinary skill in the art, taking the present application as a whole, will readily recognize that many variations are possible in the system 200 shown in FIG. 2. For example, in the exemplary basic version depicted in FIG. 2, respondent 201 might respond to the survey at a computer station 200 that includes a keyboard 205 and display 206 interconnected to a local computer 207. The computer station 200 might be a personal computer at the respondent's home or other site that serves as the source of respondent data collection.

In a variation, computer station 200 might be included in a kiosk in a public location such as might be used in a conference or shopping mall. In another variation, the computer station 200 might be implemented in a technology such as a television viewing system in which viewers respond to surveys on-line.

In yet another variation, the transmission of answers from a respondent might occur only after all questions are answered.

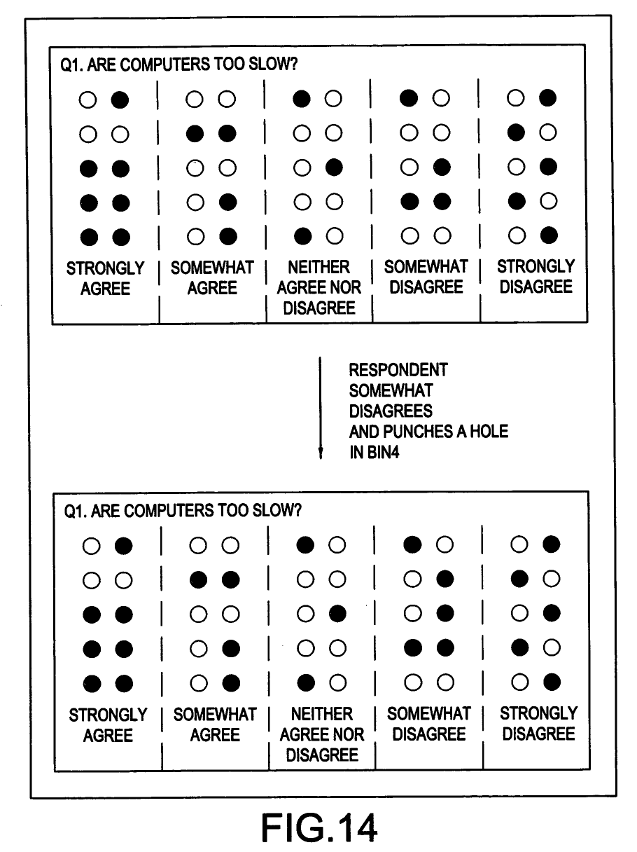

The details of the computer station 200 and the details of how responses are collected and transmitted are not so important, since this component 200 basically represents the ability for individuals 201 to enter survey responses. For instance, FIG. 14 illustrates a punch card method for collecting, perturbing and transmitting data that will be described in details later. The present invention should not be interpreted as being limited by the manner in which respondents provide the information into a database that is to be mined for data, since important aspects of the present invention would more appropriately focus on the concept of the information bin in the response, the concept of perturbing each such information bin, the concept of analyzing each bin as an aggregate, and the concept of determining distribution of the responses by then adjusting the aggregate bin result by an amount based on knowing the characteristics of the perturbation used for the bin.

The interconnection 208 between computer 207 and server 204 might be one or more components commonly used in the Internet, a local or wide area network, a high frequency link such as one using radio frequency or microwave, or an optical or satellite communication link. Again, the details of this interconnection 208 are not particularly significant, since the component basically represents the ability for the user responses to be received into a database for analysis. Indeed, one of ordinary skill in the art, taking the present application as a whole, would also readily recognize that the server 204, which in the simplistic system shown in FIG. 2, basically represents the repository for the database 203 of responses and, possibly, the repository of a data mining software module that incorporates the method of the present invention to determine the distribution of the responses. This component 204 might even be co-located with computer station 207 in, for example a publicly-located kiosk, thereby making the communication link 208 unnecessary, although for privacy considerations this is not preferred.

FIG. 2 also depicts exemplarily a user 209, such as a system administrator, having exemplarily the function of setting up the survey on the server 204, controlling the analysis process for the survey as executed by a software module in server 204, and possibly viewing, forwarding, or saving to file the results of the survey analysis. One of ordinary skill in the art, taking the present application as a whole, would readily recognize that user 209 might perform these functions by way of a computer station 210, similar to that used by the individual user 201, in that it might include a keyboard 205, display 206, and local computer 207 and an interconnection 211 between computer station 210 and server 204.

It should also be recognized that the function of computer station 210 could also be incorporated into the same computer system 204 that serves to provide the collection function of the survey results and/or the subsequent analysis of the result. There are many possible variations in implementing the details of the system that performs the function of collecting the survey results and/or the function of analyzing the survey results, and the versions described above are not intended as limiting to the method of the present invention.

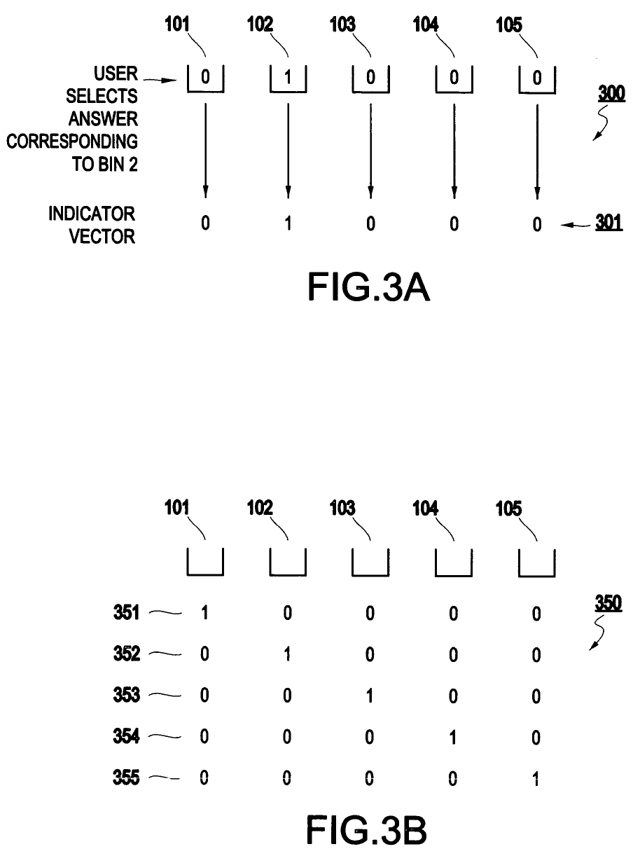

The present invention uses a specialized indicator vector to transmit a respondent's answer to a survey question into the collection database. FIG. 3a shows one exemplary encoding scheme 300 that might be used as the basis for forming the indicator vector.

In the exemplary scheme 300, each bin contains a “0” except for the bin corresponding to the response which contains a “1” (more generally, the bins initially contain a predetermined value for all bins until one or more are selected by the respondent). The indicator vector 301 is simply the vector of the bins' contents. In scheme 300 the user chooses bin 2 out of the five bins, and thus the indicator vector is (0, 1, 0, 0, 0). An alternative interpretation of this encoding scheme is shown in FIG. 3b. In the exemplary scheme 350, if the respondent responds to the survey question by indicating a response of the first bin 101, then the indicator vector is digital word 351. Similarly, a response to the second through fifth bin would generate, respectively, the indicator vectors 352 through 355. It is clear that these two interpretations are equivalent.

One of ordinary skill in the art, taking the present application as a whole, would readily recognize that other encoding schemes could be used to generate indicator vectors. For example, the ordering of the bins could be reversed in order. Moreover, as will be apparent shortly, the present invention could function with any ordering of the bins to form the indicator vector, as long as the bins are maintained consistently throughout the survey for any specific question in the survey.

That is, a key characteristic of the present invention is that the bin of a question serves as the unit to be processed in the aggregate in order to both ensure privacy and to easily extract an estimate for the distribution of the responses for the survey question.

In the scenario of FIG. 2, the indicator vector would typically be generated in the computer system 202 as being the computer used by the individual 201. However, it should be clear that this indicator vector, if it were to be transmitted to the server 204 without some sort of encryption, would clearly identify all the information contained in the respondent's answer, thereby invading the privacy of the respondent.

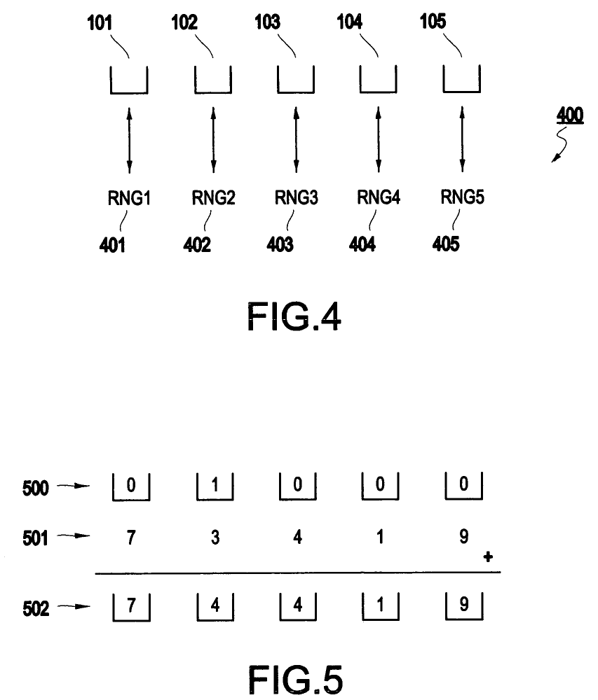

Therefore, in the present invention, as shown exemplarily in FIG. 4, for each bin 101-105, there is a correspondence 400 between the bin and a perturbation mechanism such as a random number generator (RNG). RNG can be implemented as physical noise sources which are sampled to generate the list of random numbers. Other perturbation mechanisms would be pseudo-random numbers generators implemented in hardware or software or any physical or digital mechanisms that can generate a sequences of numbers whose average is known, but the exact sequence of numbers is not.

That is, bin 101 has an affiliated RNG 1 401, and, likewise, bins 102-105 would have corresponding affiliated RNGs 402-405. The RNG for the different bins can have different probability distributions, but in the exemplary embodiment, the RNG are chosen to be independent with the same probability distribution.

These random number generators (or other perturbation mechanisms) provide a method to ensure the privacy of the response by generating random numbers and adding them to the contents of the bins. Thus for each bin, its corresponding RNG generates a random number, and this random number is added to the content of the bin. These perturbed bins will form a vector which is sent to the server for collection. Thus, given the information in the database, it would not be possible to be certain of the precise information contained in the respective bins and, therefore, not possible to be certain of the response to the survey question, as can be seen from FIG. 5.

Vector 500 is an exemplary indicator vector which is equivalent to the contents of the bins. These bins are then perturbed by adding a random number from its corresponding RNG. These random numbers are shown as 501 in FIG. 5. The resulting perturbed contents of the bins (502) form the perturbed indicator vector which is then transmitted from computer station 202 to server 203.

One of ordinary skill in the art, taking the present application as a whole, would recognize that the above description is equivalent to describing the present invention as teaching that a respondent's one or more selections to the possible selections to a survey question is first encoded into an indicator vector that precisely indicates the information of the respondent's answer. Subsequently, a perturbation vector is added to the indicator vector to provide a perturbed indicator vector, where each component of the perturbation vector includes an independent perturbation mechanism, such as a random number generator.

More specifically, the algorithm in the exemplary embodiment can be described as follows. Consider a question with k bins. If the user responds with an answer x corresponding to bin i, then each bin will have a value “0” (e.g., a first predetermined value) except for bin i which has a value “1” (e.g., a second predetermined value). The contents of the bins form an indicator vector φ(x), which is a unit vector, i.e. a vector with 0's and a single “1” (e.g., first and second predetermined values). Next k random numbers are obtained by picking k samples independently and identically distributed from a random variable W. These are denoted as (y₁, . . . , yₖ). These random numbers are added to the value of each bin.

The resulting k-vector of the values in the bins is the perturbed indicator vector and can be written as z=φ(x)+(y₁, . . . , yₖ). This is sent to the server for collection. For example, if the answer x corresponds to bin 2 with a total of 5 bins, the indicator vector will be (0, 1, 0, 0, 0). The 5 random numbers could be (4, 6, 1, 9, 3) and these numbers are added to the indicator vector resulting in the perturbed indicator vector (4, 7, 1, 9, 3) which is sent to the database for collection and data mining.

In an exemplary embodiment, the perturbed indicator vector is clamped to lie between a lower bound and an upper bound in order to reduce the number of bits that needs to be transmitted to the server. For example, if a component of the perturbed indicator vector is larger than an upper bound Bₘₐₓ, then this component is set to Bₘₐₓ. Similarly, if a component is smaller than a lower bound Bₘᵢₙ, then this component is set to Bₘᵢₙ.

Exemplarily, a software module in server 203 has the function to extract the aggregate distribution from all of the survey responses for this exemplary perturbed indicator vector 502.

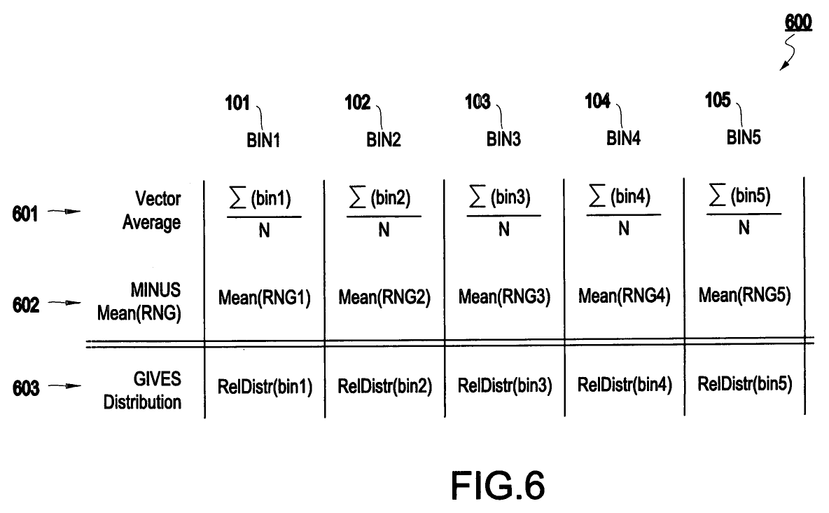

That is, for this question in the survey represented by the single vector 502, server 203 will have received N responses, with N typically a large number. FIG. 6 shows the exemplary process 600 used in the present invention to very easily extract the distribution of all responses of indicator vector 502 for this survey question.

In FIG. 6, the method to determine the distribution of answers for this specific question first involves, for each bin 101-105 separately, the calculation 601 of the average of all N received indicator vectors 502, using a straightforward process of adding up the N vectors 502 and dividing by the number N. Next, as shown in 602 of FIG. 6, the mean of the RNG for each bin 101-105 is subtracted from the vector component average, to provide the estimate 603 of the relative distribution. Note that in the computation of the average of the vectors, only a running total of the vectors is needed in memory at any one time.

This process is expressed more formally as follows. Let the perturbed indicator vectors be written as zₗ, . . . , zₙ, where each z is a k-vector and the i-th component (corresponding to bin i) of zⱼ is denoted by zⱼᵢ. The estimation of the distribution proceeds then as follows.

First, the average of all the vectors zⱼ is computed:

$$\frac{{\sum }_{j} {z}_{j}}{N} .$$

The i-th component of the average vector is then

$$\frac{{\sum }_{j} {z}_{ji}}{N} .$$

Subtracting the mean μᵢ of the RNG corresponding to the i-th bin, the estimate

$$\frac{{\sum }_{j} {z}_{ji}}{N} - {μ}_{i}$$

is obtained for the relative frequency of answers in the i-th bin. Collecting these estimates over all the bins, an estimate is obtained of the histogram of the answers to the survey question, and thus an estimate of the distribution of the answers.

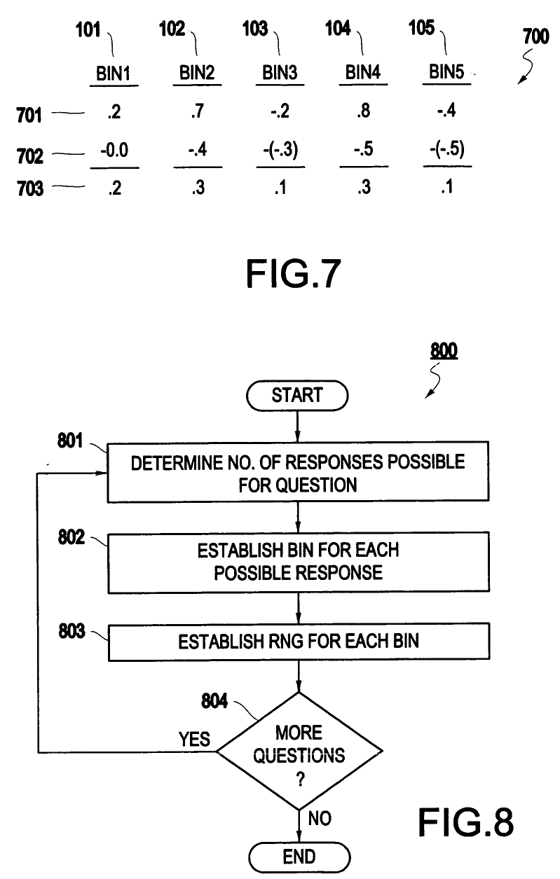

FIG. 7 shows an example 700 of the process just described, in which an exemplary averaged perturbed indicator vector 701, exemplarily including the average of the five bins 101-105, is adjusted by subtracting the mean 702 of the respective RNG for each bin, to thereby yield the estimate 703 for the distribution of answers to the survey question.

The underlying mathematical theory for the technique of the present invention is further described in two articles recently published by the inventor, C. W. Wu, “Privacy preserving data mining: a signal processing perspective and a simple data perturbation protocol”, IBM research report RC22815, Jun. 9, 2003, and C. W. Wu, “Privacy preserving data mining: a signal processing perspective and a simple data perturbation protocol”, Workshop on Privacy preserving data mining, IEEE International Conference on Data Mining 2003, Nov. 19, 2003. Copies of the first article are available by contacting IBM Research Division, Thomas J. Watson Research Center, P.O. Box 218, Yorktown Heights, N.Y. 10598 (email: reports@us.ibm.com). Some IBM reports are available on the Internet at http//domino.Watson.ibm.com/library/CyberDig.nsf/home. The second article can be found at the website: http://www.cis.syr.edu/˜wedu/ppdm2003/papers/2.pdf. These references are hereby incorporated by reference.

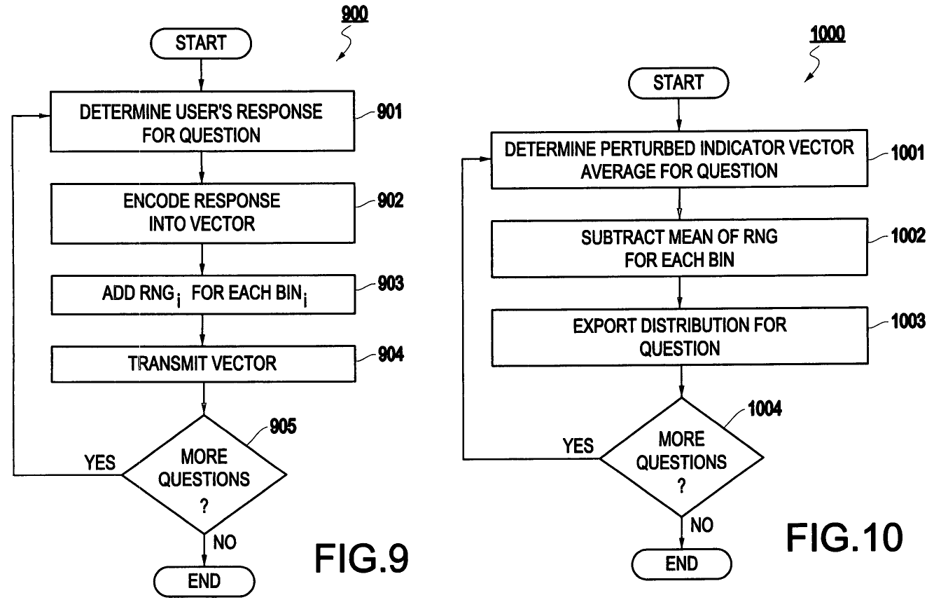

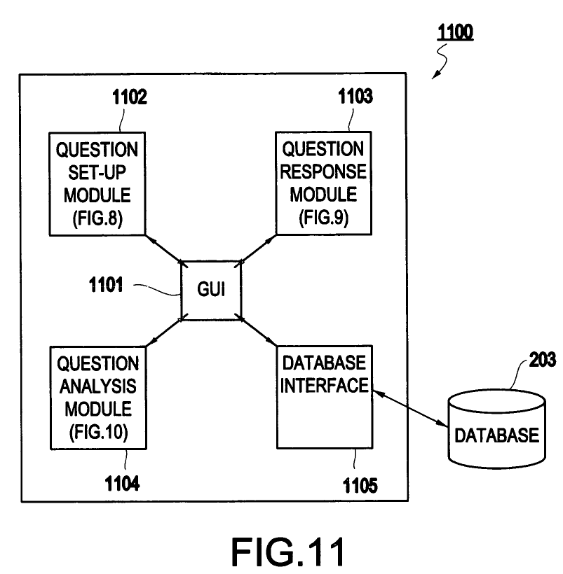

FIG. 8 illustrates a flowchart of an exemplary method 800 that might be used to set up a survey question for the method of the present invention.

In step 801, the software module determines the number of responses possible for the question.

In step 802, a bin is established for each possible response, and in step 803, a random number generator (RNG) is initiated for each bin.

The choice of the RNG and its probability distribution (described by W above) depend on the application and on the suspected probability distribution of the responses from the users. In order to efficiently transmit and store the perturbed indicator vector, it is preferable that samples from W are integers or fractions with small denominators. To effectively mask the responses, the RNG should generate numbers from a large range. In an exemplary embodiment, the RNG could generate the nonnegative integers 0, 1, 2, . . . where the probability of generating the integer m is 2^{-m-1}. As described above, the perturbed indicator vector can be clamped to within a range of upper and lower values before sending it to the server. The references by the inventor cited earlier provide further details on this and other choices of RNG.

In step 804, the next question, if any, is similarly set up by establishing bins for the question and an RNG for each bin. Since the RNG is established in this step, it is straightforward to store in memory the mean for each RNG, as would be required for the step of estimating the distribution as described above. Since all the respondents use an RNG with the same probability distribution, the mean is known to the server during the setup of the survey.

FIG. 9 shows a flowchart 900 for one exemplary software module at the respondent's computer station.

In step 901, the software module receives the respondent's answer to the survey question. In step 902, the respondent's answer is encoded into an indicator vector, such as exemplarily shown in FIG. 3, in which the information content is totally preserved.

In step 903, the indicator vector corresponding to the respondent's answer is then perturbed by the RNG for each bin, and, in step 904, this perturbed indicator vector is then transmitted to the database, either immediately, or after all questions have been answered. In step 905, the next question, if any, is similarly encoded into an indicator vector, perturbed, and transmitted to the database.

FIG. 10 shows a flowchart for an exemplary method 1000 for the estimate of the distribution of the respondents' answers for a question.

In step 1001, the average for each bin in the perturbed indicator vectors is calculated by adding up all, for each bin, the contents of the bin for each perturbed indicator vector and then dividing by the number of respondents.

In step 1002, for each bin, the mean of the RNG is then subtracted from the average of the bin, and, in step 1003, the relative distribution is exemplarily exported from the software module for either storage in a file or for display. In step 1004, the next question is similarly dealt with, by looping back to step 1001.

It should be apparent that computation in the analysis stage could be somewhat simplified if the RNGs were specifically constrained to have zero mean (e.g., RNGs having Gaussian distribution with a mean equal to zero). Note that any RNG can be transformed into a RNG with zero mean by subtracting the mean from the output of the RNG. This is equivalent to moving step 1002 in FIG. 10 to after step 903 in FIG. 9, i.e., subtracting the mean from the perturbed indicator vector before transmitting it to the database in step 904 (rather than subtracting the mean in the database (step 1002)). However, as pointed out in the references by the inventor cited above, there are some other requirements, such as the RNG generating integers in order to reduce storage and transmission requirements of the perturbed indicator vectors, that results in the mean to be nonzero.

FIG. 11 illustrates exemplarily the software modules 1100 that might be used to implement the present invention. A graphic user interface (GUI) 1101 allows a user to enter data and instructions. It is noted that a GUI would be necessary for the function of servicing the individual responding to the survey questions and to encode and perturb the respondent's answers, for the function of initially setting up the survey questions, for the function of controlling the calculation of the distribution estimation, and for the function of storing or displaying the result of the distribution estimation.

In the exemplary embodiment of FIG. 11, the one or more GUIs would then interface with the software modules 1102, 1103, 1104 that correspond with the exemplary flowcharts of FIGS. 8, 9, and 10. Additionally, database module 1105 allows the respondents' indicator vectors to be stored into and retrieved out of a memory device 203.

To ensure that the server does not see the unperturbed indicator vector, the perturbation is preferably done at the respondent's computer. Furthermore, as in the conventional method, the random numbers generated by the RNG should be tied to the answer of the respondent, so that repeated queries to the same respondent on the same question retrieve the same perturbed indicator vector.

In another embodiment, the perturbation for each answer is taken from a parameterized family of perturbation. In this case, an additional RNG is needed to generate an auxiliary value. Corresponding to each indicator vector, this RNG generates an auxiliary value that is used to parameterize a family of perturbations in order to determine the specific RNG's that will generate the random values to perturb this indicator vector. The auxiliary value is sent to the server along with the perturbed indicator vector. At the server, these auxiliary values are used to create the average of all the perturbations used for the different answers. The mean of this average perturbation (which is equal to the average mean of the perturbations) is then subtracted from the average perturbed indicator vector to obtain an estimate of the distribution.

In yet another embodiment, the bins overlap (e.g. bin 1 denotes the age range [0-29], whereas bin 2 denotes the age range [19-39]). In this case after subtracting the mean from the average perturbed indicator vector, the result needs to be processed further to obtain the histogram estimate of the distribution.

The above-referenced articles by the inventor provide more information on these embodiments.

In yet another embodiment, the data collection, perturbation and transmission are done through a paper ballot such as a punch card as exemplarily illustrated in FIG. 14. Each respondent will use a punch card for each question as shown in FIG. 14. Of course, several questions can be put on the punch card by repeating the setup in FIG. 14 for the different questions on the same card. The question is printed on the card. Corresponding to each possible response to the question (i.e. a bin) is an area on the card of punched and unpunched holes.

In FIG. 14, the black circles indicate punched holes and the white circles indicate unpunched holes. Each response has some holes punched. To answer the question, the respondent punches an unpunched hole corresponding to the response he or she chooses. If all holes have already been punched in the area for that response, then the respondent does nothing. The punching can be done with a specialized machine so that the hole punched by the respondent is indistinguishable from the punched holes that were already there. Then, this card will be collected by the data mining party to determine the distribution of the responses.

It is clear that this method of data collection, perturbation and transmission is parallel to the computer-based setup in FIG. 2. The number of holes punched before the question is answered corresponds to the random number for that bin. The punching of an additional hole by the respondent corresponds to adding the indicator vector to the random numbers. When all the holes are punched in a bin, this corresponds to clamping to an upper bound, and the total number of punched and unpunched holes in a bin corresponds to Bₘₐₓ. For each such card, the server generates the perturbed indicator vector by counting the number of punched holes in each bin.

Instead of punching holes, other methods of marking can be used such as filling in a circle using ink. The main idea is to have a number of markable spots for each possible response (or bin) with a random number of such spots already marked for each response. The respondent responds by marking an unmarked spot in the bin corresponding to his or her response.

One of ordinary skill in the art, taking the present application as a whole, would readily recognize that these modules might be combined into a single software program with each module being used depending upon which function is currently being performed. Alternatively, the various appropriate modules could reside in, for example, the computers 204, 206 shown in FIG. 2.

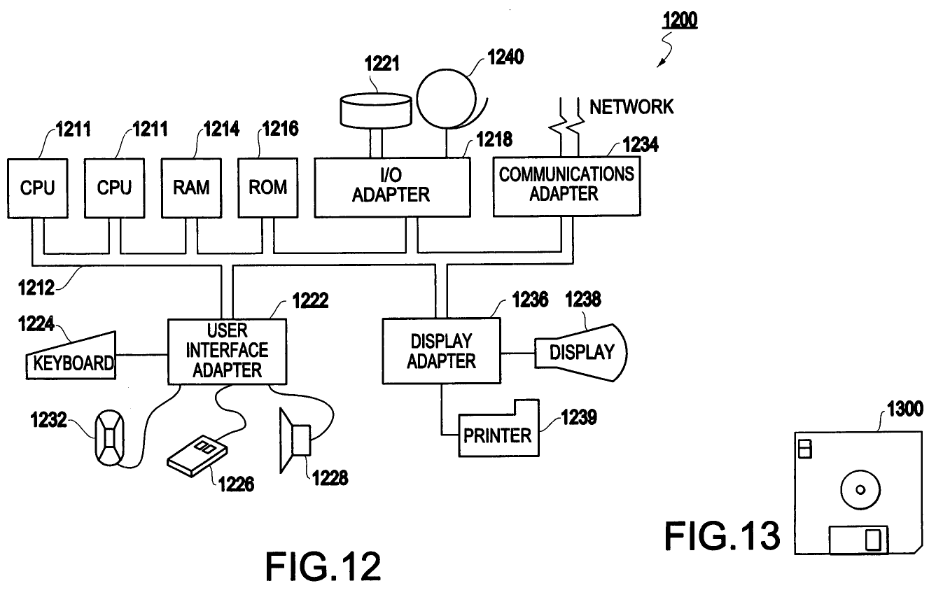

FIG. 12 illustrates a typical hardware configuration of an information handling/computer system 1200 in accordance with the invention and which preferably has at least one processor or central processing unit (CPU) 1211. Information handling/computer system 1200 might, for example, represent the computers 204, 206 shown in FIG. 2.

The CPUs 1211 are interconnected via a system bus 1212 to a random access memory (RAM) 1214, read-only memory (ROM) 1216, input/output (I/O) adapter 1218 (for connecting peripheral devices such as disk units 1221 and tape drives 1240 to the bus 1212), user interface adapter 1222 (for connecting a keyboard 1224, mouse 1226, speaker 1228, microphone 1232, and/or other user interface device to the bus 1212), a communication adapter 1234 for connecting an information handling system to a data processing network, the Internet, an Intranet, a personal area network (PAN), etc., and a display adapter 1236 for connecting the bus 1212 to a display device 1238 and/or printer 1239 (e.g., a digital printer or the like). As an example, the method of the present invention may be implemented in the particular environment discussed above.

Such a method may be implemented, for example, by operating a computer, as embodied by a digital data processing apparatus, to execute a sequence of machine-readable instructions. These instructions may reside in various types of signal-bearing media.

Thus, this aspect of the present invention is directed to a programmed product, comprising signal-bearing media tangibly embodying a program of machine-readable instructions executable by a digital data processor incorporating the CPU 1211 and hardware above, to perform the method of the invention.

This signal-bearing media may include, for example, a RAM contained within the CPU 1211, as represented by the fast-access storage, for example. Alternatively, the instructions may be contained in another signal-bearing media, such as a magnetic data storage diskette 1300 (FIG. 13), directly or indirectly accessible by the CPU 1211.

Whether contained in the diskette 1300, the computer/CPU 1211, or elsewhere, the instructions may be stored on a variety of machine-readable data storage media, such as DASD storage (e.g., a conventional “hard drive” or a RAID array), magnetic tape, electronic read-only memory (e.g., ROM, EPROM, or EEPROM), an optical storage device (e.g. CD-ROM, WORM, DVD, digital optical tape, etc.), paper “punch” cards, or other suitable signal-bearing media including transmission media such as digital and analog and communication links and wireless. In an illustrative embodiment of the invention, the machine-readable instructions may comprise software object code.

In yet another aspect, the present invention might also be implemented as a business or service method in which, as shown exemplarily by the user 209 in FIG. 2, a business entity conducts a survey in accordance with the method of the present invention.

That is, user 209 might be an employee of a business or organizational entity that uses the present invention to conduct any type of a survey, such as a marketing or other such consumer survey or a public opinion or political survey. One of ordinary skill in the art, taking the present application as a whole, would also readily recognize that user 209 might also be an employee of a business entity that specializes in the implementation of surveys on behalf of an external (or internal) client.

This aspect of the present invention is intended as being covered in its entirety by the present invention. That is, it is intended that the present invention includes the implementation of the methods discussed above, whether the methods are actually executed by an entity or executed on behalf of another entity.

It is also intended that the present invention includes a partial implementation of the methods described above. That is, if an entity executes only specific steps in the methods described above, this partial implementation is intended to be covered by the present invention. Partial implementations of the present invention might include, for example, any or all of the following:
the preparation of the survey questions in a format to execute the present invention;
the provision to allow users to respond to a survey in the method described above;
the provision to allow users to respond to a survey by making markings on a card as described above;
the reception and storage of survey questions as prepared in the manner described above;
the transmission of perturbed indicator vectors as described above;
the reception of perturbed indicator vectors as described above, as received from respondents;
storing received perturbed indicator vectors or an aggregate of received vectors in a database for analysis;
the processing of perturbed indicator vectors, as described above;
the transmittal of analysis of the database, whether by hard copy or by soft copy; and
the receipt of analysis of the estimated distribution, whether by hard copy or by softcopy.

While the invention has been described in terms of exemplary embodiments, those skilled in the art will recognize that the invention can be practiced with modification within the spirit and scope of the appended claims.

Further, it is noted that, Applicants' intent is to encompass equivalents of all claim elements, even if amended later during prosecution.

1. A method of conducting a survey, said method comprising:
for at least one question in said survey, establishing a bin for each of a possible response to said question; and
for each said bin, establishing a perturbing mechanism that perturbs a content of said bin, said perturbing mechanism having a statistical parameter with a known value.

2. The method of claim 1, further comprising;
generating a perturbed indicator vector that represents a respondent's response for said question, said perturbed indicator vector comprising an information structure including the contents of all bins of said question after each of the bins has been perturbed and said respondent has selected one or more said possible responses.

3. The method of claim 1, wherein said perturbing mechanism comprises a random number generator and said known statistical parameter value comprises a mean value of said random number generator.

4. The method of claim 2, wherein said generating the perturbed indicator vector comprises respectively adding numbers from the perturbing mechanism to the contents of the bins.

5. The method of claim 4, further comprising:
if contents of a bin exceeds an upper bound after perturbation, said contents are clamped to said upper bound.

6. The method of claim 4, further comprising:
if contents of a bins are below a lower bound after perturbation, said contents are clamped to said lower bound.

7. The method of claim 1, further comprising at least one of:
setting up a survey question by generating a medium with a plurality of markable areas for each possible response and pre-marking a random number of said markable areas for each said possible response; and
having a respondent respond to the survey question by adding a mark to any of remaining non pre-marked markable areas, if any markable areas remain after said pre-marking, of the plurality of markable areas for the possible response that corresponds to a desired response to the question.

8. The method of claim 7, further comprising:
generating a perturbed indicator vector by counting the number of marked areas for each response.

9. The method of claim 2, further comprising:
for a plurality of responses for a question in said survey, analyzing the bins in said perturbed indicator vector to provide an estimation of a distribution of responses.

10. The method of claim 9, wherein said analyzing comprises:
for said question being analyzed, calculating an average of each perturbed bin in said question.

11. The method of claim 10, wherein said perturbing mechanism comprises a random number generator and said known statistical parameter comprises a mean value, said analyzing further comprising:
for each said perturbed bin in said question, subtracting said mean value of said perturbing mechanism associated with said bin.

12. The method of claim 1, further comprising:
for each perturbed bin in said question, adjusting a content of said perturbed bin by an amount of said known value of said statistical parameter.

13. An apparatus for conducting a survey, said apparatus comprising at least one of:
a memory for storing a plurality of respondents' responses to a question in said survey, wherein each of said respondents' response comprises a bin for each of a possible response to said question and a value of each said bin has been perturbed by a perturbing mechanism;
a survey question set-up module to allow a question in said survey to be set up, said survey question set-up module including a module to establish a bin for each of a possible response to said question and a perturbing mechanism for each said bin that perturbs a content of said bin, each said perturbing mechanism having a known value for a statistical parameter;
a respondent module including a selection module to allow a respondent to select at least one of said possible responses to said question and a module to apply said perturbing mechanism for each said bin to generate a perturbed indicator vector corresponding to said respondent's selection;
an analysis module to retrieve data from said database for said question and to analyze each said bin; and
a graphic user interface to allow a user to interface with at least one of said memory, said survey question set-up module, said respondent module, and said analysis module.

14. The apparatus of claim 13, wherein said memory stores a running sum of the perturbed indicator vectors.

15. The apparatus of claim 13, wherein said analysis module calculates an average value of each said bin of said question by dividing a sum of the contents in said bin of the perturbed indicator vectors by the number of respondents.

16. A system for conducting a survey, comprising at least one of:
a memory means for serving as a database to store a plurality of respondent's responses to a question in said survey, wherein each said response comprises a plurality of bins corresponding to a number of possible answers for said question and each said bin is perturbed in value by a perturbing mechanism;
a survey set-up means for setting up a question in said survey, wherein said setting up said question comprises establishing a bin for each of a possible response to said question and establishing a perturbing mechanism that perturbs a content of said bin, said perturbing mechanism having a statistical parameter with a known value;
a respondent means for allowing a respondent to select at least one of said possible answers to said question, for perturbing a content of each bin in said question upon completion of the selection by said respondent, for generating a perturbed indicator vector that includes the contents of all said bins in said question after perturbation, and for transmitting said perturbed indicator vector to said database; and
an analysis means for retrieving and analyzing a content of said bins; and
a user interface means for allowing a user to interface with at least one of said memory means, said survey set-up means, said respondent means, and said analysis means.

17. A system for conducting a survey as in claim 16, wherein said memory means stores a running sum of the perturbed indicator vectors.

18. A system for conducting a survey as in claim 16, wherein said analysis means calculates an average value for said bin by dividing, by the number of respondents being analyzed, the sum of the contents of said bin for all said respondents being analyzed.

19. A signal-bearing medium tangibly embodying a program of machine-readable instructions executable by a digital processing apparatus to perform a method of at least one of conducting, processing, and analyzing a survey, said program comprising at least one of:
a memory interface to interface with a database that stores a plurality of responses to a question in said survey, wherein each said response comprises a perturbed vector comprising a bin for each of a possible response for said question, as perturbed by a perturbing mechanism having a known value for a statistical parameter;
a survey set-up module to allow a question in said survey to be set up, wherein said set-up module establishes a bin for each of a possible response to said question, and establishes a perturbing mechanism to perturb a content of said bin, said perturbing mechanism having a known value for a statistical parameter;
a respondent module to allow a respondent to select at least one of said possible responses to said question, to perturb a content of each bin in said question upon completion of the selection, to generate a perturbed indicator vector that includes the contents of all said bins in said question after perturbation, and to send said perturbed indicator vector to said database;
an analysis module to retrieve from said database and analyze data for said question; and
a graphic user interface to allow a user to interface with at least one of said memory device, said survey set-up module, said respondent module, and said analysis module.

20. The signal-bearing medium of claim 19, wherein said memory interface includes instructions to store a running sum of the perturbed indicator vectors.

21. The signal-bearing medium of claim 20, wherein said analysis module calculates an average value by dividing the sum of the contents of a bin of said perturbed indicator vectors by the number of respondents being analyzed.

22. A business method, comprising at least one of:
preparing a survey question in a manner such that, for at least one question in said survey, establishes a bin for each of a possible response to said question, for each said bin, establishes a perturbing mechanism that perturbs a content of said bin, said perturbing mechanism having a known value for a statistical parameter;
allowing users to respond to said survey question;
at least one of receiving and storing said survey question;
transmitting a perturbed indicator vector of a respondent's response to a survey question prepared in said manner, said perturbed indicator vector comprising an information structure including the contents of all bins of said question after each of the bins has been perturbed;
at least one of receiving said perturbed indicator vector and storing said perturbed indicator vector in a database;
at least one of retrieving and analyzing data for said survey question to provide a result of said survey; and
at least one of transmitting, receiving, printing out, and receiving a printed copy of said result.

23. A method of conducting a survey, said method comprising:
for at least one question in said survey, generating an indicator vector from a vector whose components respectively represent a possible response to said question, said indicator vector indicating which of said possible responses were selected by a respondent; and
adding a perturbation vector to said indicator vector to provide a perturbed indicator vector,
said perturbation vector having a same number of components as said indicator vector, each component in said perturbation vector resulting from a perturbation mechanism that is independent of the perturbation mechanism of the other components, wherein said perturbation mechanism has a statistical parameter whose value is known.

24. The method of claim 23, wherein said perturbation mechanism comprises a random number generator and said statistical parameter comprises a mean, said method further comprising:
for each at least one question in said survey, calculating an average perturbed indicator vector from a plurality N of perturbed indicator vectors, wherein vector components of said average perturbed indicator vector respectively comprise an average value of corresponding components in said plurality N of perturbed indicator vectors; and
subtracting from said average perturbed indicator vector a mean vector whose components respectively comprise said mean value of said perturbation mechanism for each said indicator vector component.

25. A method of privacy-preserving data mining, comprising:
for at least one question in a survey used in said data mining, generating an indicator vector from a vector whose components represent each possible response to said question, said indicator vector indicating which of said possible responses were selected by a respondent; and
adding a perturbation vector to said indicator vector to provide a perturbed indicator vector, said perturbation vector having a same number of components as said indicator vector, each component in said perturbation vector resulting from a perturbation mechanism that is independent of the perturbation mechanism of the other components, wherein each said perturbation mechanism has a statistical parameter with a value that is known.

26. A data mining apparatus, comprising:
an indicator vector generator to generate an indicator vector representing a response by a respondent to a survey question;
a perturbation vector generator to generate a perturbation vector; and
a perturbed indicator vector generator to add said indicator vector with said perturbation vector,
wherein, for said question, a predefined possible-response vector exists whose components respectively represent a possible response to said question, said indicator vector comprising a modification of said possible-response vector that represents which one or ones of said possible responses were selected by a respondent, said perturbation vector comprising a vector having a same number of components as said indicator vector, each component in said perturbation vector resulting from a perturbation mechanism that is independent of the perturbation mechanism of the other components, each said perturbation mechanism having a statistical parameter with a value that is known.

27. A signal-bearing medium tangibly embodying a program of machine-readable instructions executable by a digital processing apparatus to perform a method of conducting a survey, said program comprising:
an indicator vector generator to generate an indicator vector representing a response by a respondent to a survey question;
a perturbation vector generator to generate a perturbation vector; and
a perturbed indicator vector generator to combine said indicator vector with said perturbation vector,
wherein, for each said question, a possible-response vector exists whose components respectively represent a possible response to said question, said indicator vector comprising a modification of said possible-response vector that represents which of said possible responses were selected by a respondent, said perturbation vector comprising a vector having a same number of components as said indicator vector, each component in said perturbation vector resulting from a perturbation mechanism that is independent of the perturbation mechanism of the other components, each perturbation mechanism having a statistical parameter with a known value.
